(19) United States
(12) Patent Application Publication
(10) Pub. No.: US 2002/0107751 A1
(43) Pub. Date: Aug. 8, 2002

(54) Method and system for configuring assembled manual motor controllers

(76) Inventors: Muthaiya Rajagopalan, Plainville, CT (US); Loknath Esety Patro, Plainville, CT (US); Michael A. Motley, Simsbury, CT (US); Charles Stephen Pitzen, Farmington, CT (US)

Correspondence Address: John S. Beulick, Armstrong Teasdale LLP, Suite 2600, One Metropolitan Sq., St. Louis, MO, 63102, US

(21) Appl. No.: 09/779,236

(22) Filed: Feb. 8, 2001

(51) Int. Cl. G06F 17/60

(52) U.S. Cl. 705/26

(57) ABSTRACT

A network-based method for configuring assembled manual motor controllers includes receiving assembled manual motor controller specification information from a user and using a server to compare the received specification information with pre-stored information. The method also includes selecting at least one assembled manual motor controller that matches the received specification information and displaying to the user information related to the assembled manual motor controller. A network-based method also provides for selection of a various accessories for the selected assembled manual motor controller.

### BACKGROUND OF THE INVENTION

This invention relates generally to computer network-based systems and more particularly to a network-based method and system for configuring assembled manual motor controllers.

Assembled manual motor controllers are used in electric equipment and machinery, but identifying a correct assembled manual motor controller for a specific application is not always an easy task. Many parameters should be considered, and each combination of parameters could demand a specific product for optimum performance.

Therefore, it would be desirable to quickly determine a proper product to be used for different combinations of parameters. In addition, it would be desirable to determine if a particular product provides adequate performance for equipment, machinery, or a facility.

### BRIEF SUMMARY OF THE INVENTION

In an exemplary embodiment, an assembled manual motor controller selection system allows users to select the most appropriate assembled manual motor controller for their application needs over the Internet. The system guides a web user to answer several pre-arranged questions interactively about the product attributes and then uses those inputs to direct the user to a uniquely configured product having a specific catalog number. If the user's input combination results in an invalid configuration, the user receives messaging to guide the user to a valid alternative. The system allows both experienced and novice users to place orders directly for assembled manual motor controllers through use of the Internet.

The network-based method for selecting a correctly assembled manual motor controller includes receiving product specification information from a user and comparing the received product specification information with pre-stored assembled manual motor controller information. If at least one assembled manual motor controller matches the received user criteria for the assembled manual motor controller, the pre-stored assembled manual motor controller information is downloaded for communication to the user.

The product information may include, for example, features of the product and accessories of the product. The method further includes validating configuration compatibility based on product information data and features of the product to determine whether a resulting product is capable of desired performance for a set of given product parameters.

### BRIEF DESCRIPTION OF THE DRAWINGS

FIG. 1 is a block diagram of a system in accordance with one embodiment of the present invention;

FIG. 2 is an expanded version block diagram of an exemplary embodiment of a server architecture of an alternative system;

FIG. 3 is a flow diagram of a network-based method for configuring assembled manual motor controllers;

FIG. 4 is an exemplary embodiment of an assembled manual motor controller—needs assessment page;

FIG. 5 is an exemplary embodiment of an assembled manual motor controller—features page;

FIG. 6 is an exemplary embodiment of an assembled manual motor controller—accessories page;

FIG. 7 is an exemplary embodiment of an assembled manual motor controller—enclosures page;

FIG. 8 is an exemplary embodiment of an assembled manual motor controller—contactors page;

FIG. 9 is an exemplary embodiment of an assembled manual motor controller—exception message page; and

FIG. 10 is an exemplary embodiment of an assembled manual motor controller—Bill of Material page.

### DETAILED DESCRIPTION OF THE INVENTION

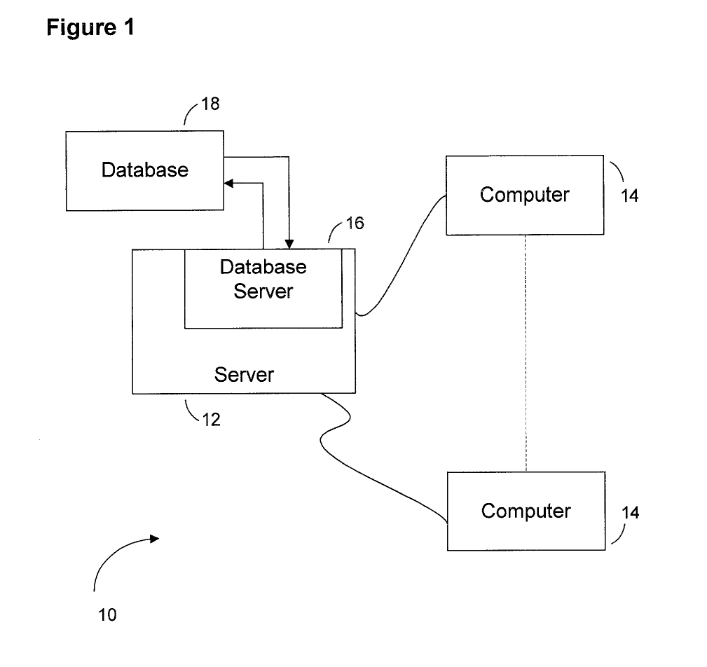

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing assembled manual motor controller information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

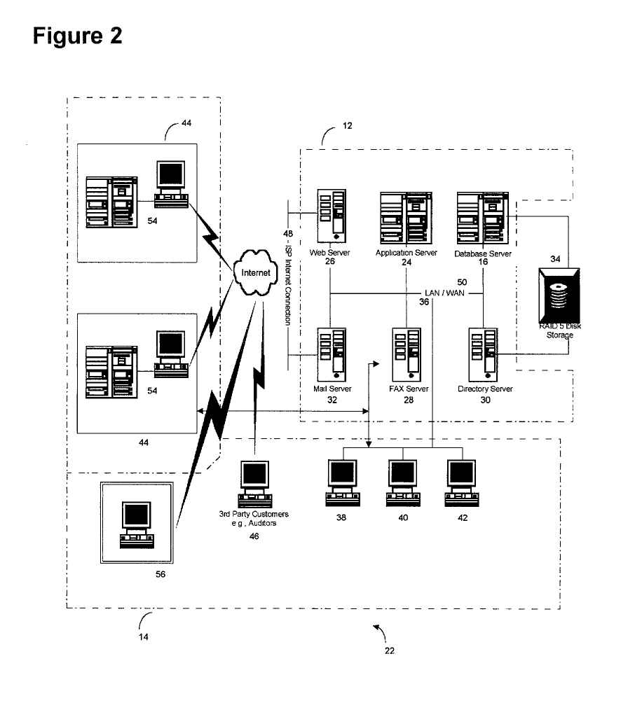

FIG. 2 is an expanded version block diagram of an exemplary embodiment of a server architecture of a system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 54 can access server sub-system 12. One of user devices 14 includes a workstation 54 located at a remote location. Workstations 54 are personal computers having a web browser. Also, workstations 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

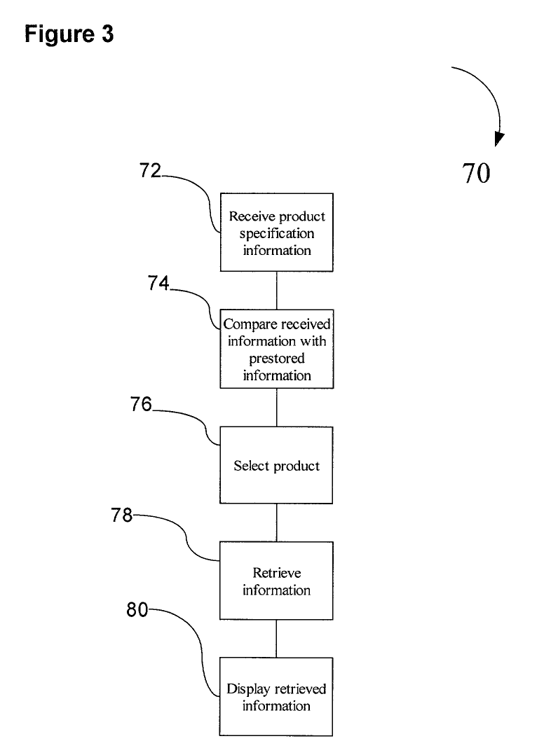

FIG. 3 is a flow diagram 70 for a network-based method for configuring assembled manual motor controllers. In one embodiment, the assembled manual motor controller selection involves selection of assembled manual motor controllers. System 10 (shown in FIG. 1) receives 72 product specification information from a user. In one embodiment, the user inputs the information into a device (such as device 14 shown in FIG. 1) that transmits the information to a server (such as server 12 shown in FIG. 1). The product specification information is received from the user via a graphical user interface as will be described in greater detail below.

Server 12 compares 74 the received assembled manual motor controller related requirements to pre-stored information accessible by server 12. In one embodiment, the pre-stored information is stored in a database that resides on server 12. In an alternative embodiment, the pre-stored information is stored in a database remote from server 12. The pre-stored information includes various types and configurations of assembled manual motor controller related information. Server 12 compares the user provided information to the pre-stored information to determine if any pre-stored assembled manual motor controller information contained in the database satisfy the product specifications/requirements submitted by the user.

In addition, server system 12 assesses the information supplied by the user to validate configuration compatibility of the product. Exemplary information includes product application, product parameters, desired product features, and product accessories. System 10 evaluates the information supplied by the user and determines whether a resulting product incorporating an assembled manual motor controller having the received product specifications is capable of meeting parameters of the indicated product. For example, system 10 determines whether a selected assembled manual motor controller with a given requirement is available to satisfy the user, and, if the selected assembled manual motor controller with a given requirement is not available, system 10 displays a message to the user that the assembled manual motor controller with the required product characteristics is not available and that the user should select an alternative product. In summary, system 10 reviews the user input and based on a pre-determined assembled manual motor controller configuration as well as operating specifications, the user is provided feedback for a specific assembled manual motor controller that meets the criteria for the user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored assembled manual motor controller information that matches the information entered by the user and selects 76 assembled manual motor controller configurations from the pre-stored information. System 10 retrieves 78 information pertaining to the selected assembled manual motor controller configuration. In one embodiment, the assembled manual motor controller information includes an assembled manual motor controller identifier number and associated price for each selected assembled manual motor controller configuration. For example, the assembled manual motor controller identifier number is a catalog number and the price is a list price of the product. Server 12 then transmits the retrieved identifier number and associated price and downloads the retrieved assembled manual motor controller information to user device 14 for display 80 so that the user can view the information. In an alternative embodiment, system 10 uses the list price information to generate a quotation for each selected assembled manual motor controller configuration including the indicated features and accessories and server 12 then transmits the retrieved assembled manual motor controller identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against pre-determined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

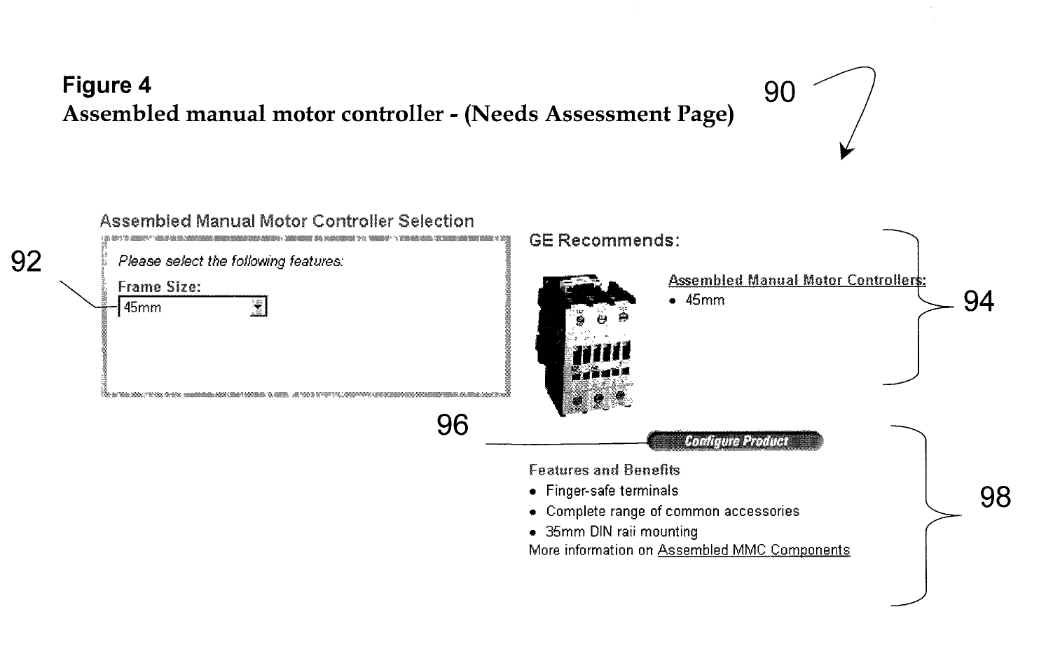

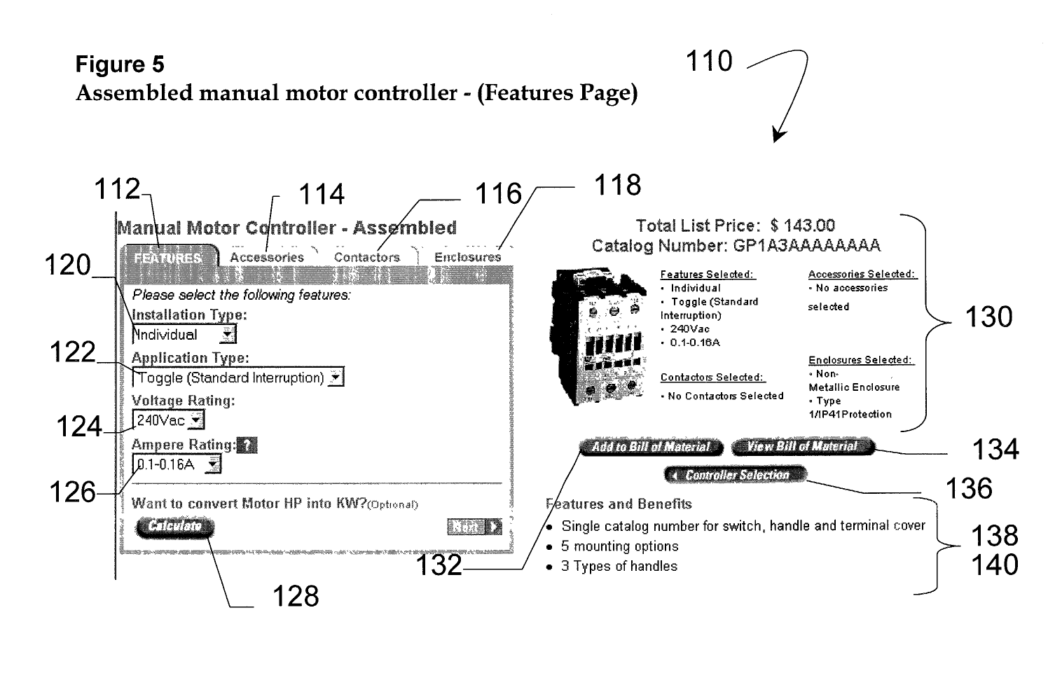

FIG. 4 shows an exemplary embodiment of an assembled manual motor controller—assembled needs assessment page, as depicted in screen shot 90. Screen shot 90 includes a Frame Size pull down menu 92, a recommendation display area 94, a Configure Product button 96, and a Features and Benefits display area 98. Selection of Configure Product button 96 causes system 10 (shown in FIG. 1) to display an assembled manual motor controller features main page, as shown in FIG. 5.

FIG. 5 shows an exemplary embodiment of an assembled manual motor controller—assembled features page, as depicted in screen shot 110. Screen shot 110 includes a Features tab 112, an Accessories tab 114, a Contactors tab 16, and an Enclosures tab 118. Screen shot 110 results from selection of Features tab 112, and includes an Installation Type pull down menu 120, an Application pull down menu 122, a Voltage Rating pull down menu 124, and an Ampere Rating pull down menu 126. Screen shot 110 also includes a Calculate button 128 for converting motor horsepower into kilowatts, and a recommendation display area 130 that displays information about a recommended assembled manual motor controller, including in one embodiment a price. Screen shot 110 further includes an Add to Bill of Material button 132, a View Bill of Material button 134, and a Controller Selection button 136. Screen shot 110 still further includes a Features and Benefits display area 138.

Selection of Add to Bill of Material button 132 adds the selected item to the bill of material. View Bill of Material button 134 causes system 10 (shown in FIG. 1) to display a Bill of Material page, discussed below. Controller Selection button 136 takes the user to the assembled manual motor controller needs assessment page, shown in FIG. 4.

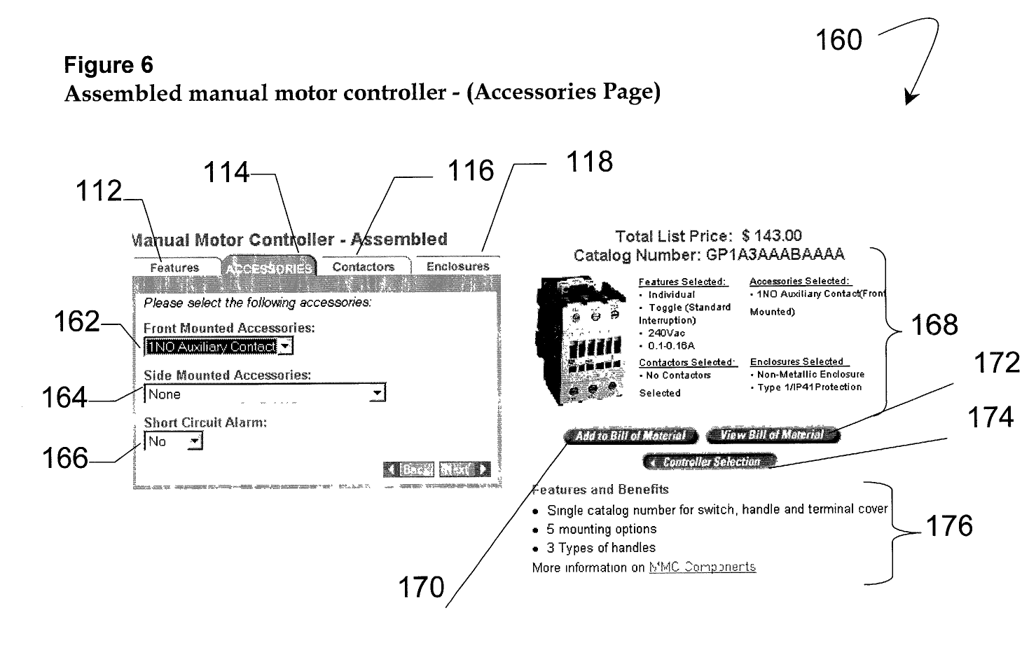

FIG. 6 shows an exemplary embodiment of an assembled manual motor controller—assembled accessories page, as depicted in screen shot 160. Screen shot 160 results from selection of Accessories tab 114 shown in FIG. 5, and includes a Front Mounted Accessories pull down menu 162, a Side-Mounted Accessories pull down menu 164, and a Short Circuit Alarm pull down menu 166. Screen shot 160 also includes a recommendation area 168 that in one embodiment includes a list price of a recommended product, as well as an Add to Bill of Material button 170, a View Bill of Material button 172, and a Controller Selection button 174. Screen shot 160 further includes a Features and Benefits display area 176 that displays further information about the recommended product.

Selection of Add to Bill of Material button 170 adds the selected item to the bill of material. View Bill of Material button 172 causes system 10 (shown in FIG. 1) to display a Bill of Material page, discussed below. Controller Selection button 174 takes the user to the assembled manual motor controller needs assessment page, shown in FIG. 4.

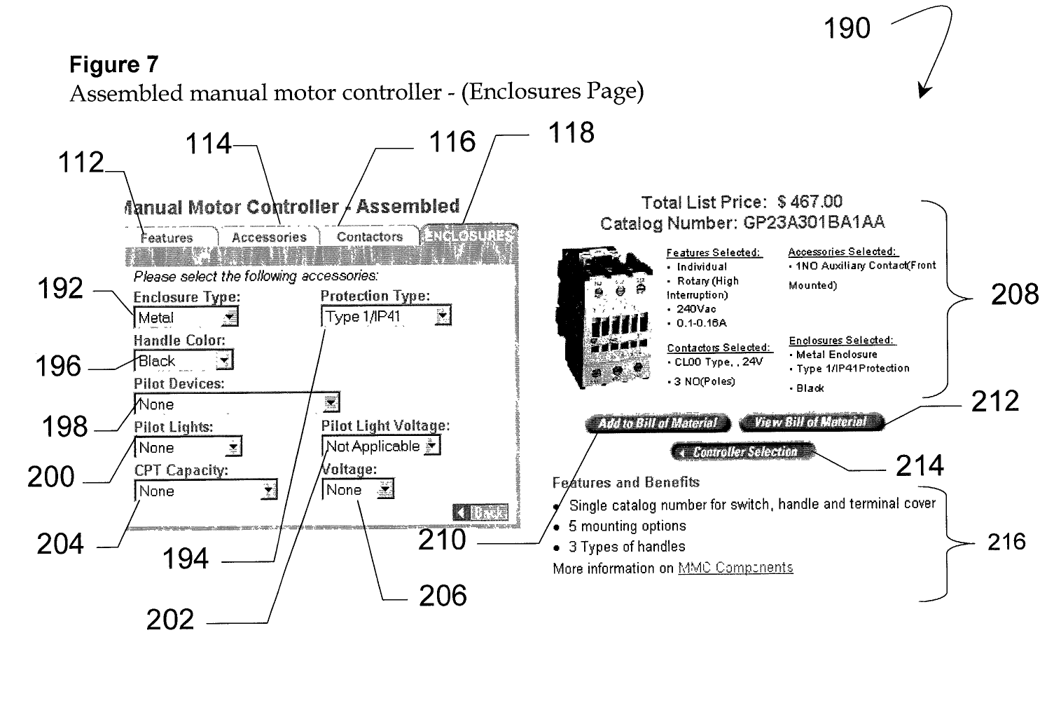

FIG. 7 shows an exemplary embodiment of an assembled manual motor controller—assembled enclosures page, as depicted in screen shot 190, which results from selection of Enclosures tab 118 shown in FIG. 5. Screen shot 190 includes an Enclosure Type pull down menu 192, a Protection Type pull down menu 194, a Handle Color pull down menu 196, a Pilot Devices pull down menu 198, a Pilot Lights pull down menu 200, a Pilot Light Voltage pull down menu 202, a CPT Capacity pull down menu 204, and a Voltage pull down menu 206. Screen shot 190 also includes a recommendation area 208 that specifies further information about the recommended product that in one embodiment includes a list price. Screen shot 190 also includes an Add to Bill of Material button 210, a View Bill of Material button 212, and a Controller Selection button 214, as well as a Features and Benefits display area 216.

Selection of Add to Bill of Material button 210 adds the selected item to the bill of material. View Bill of Material button 212 causes system 10 (shown in FIG. 1) to display a Bill of Material page, discussed below. Controller Selection button 214 takes the user to the assembled manual motor controller needs assessment page, shown in FIG. 4.

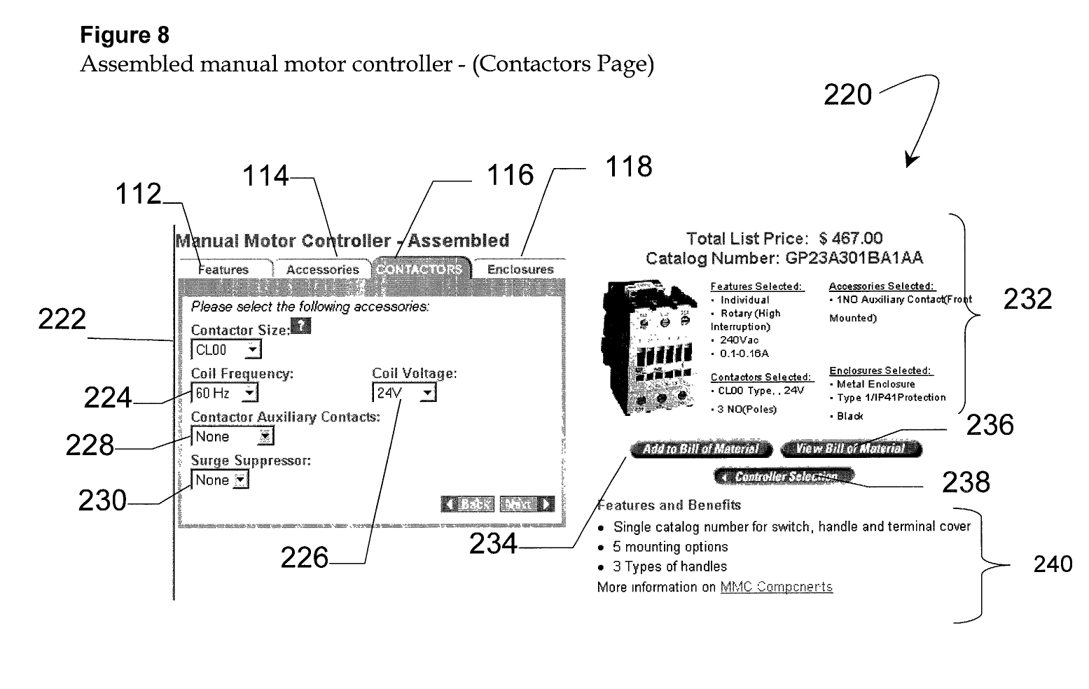

FIG. 8 shows an exemplary embodiment of an assembled manual motor controller—assembled contactors page, as depicted in screen shot 220, which results from selection of Contactors tab 116 shown in FIG. 5. Screen shot 220 includes a Contactor Size pull down menu 222, a Coil Frequency pull down menu 224, a Coil Voltage pull down menu 226, a Contactor Auxiliary Contacts pull down menu 228, and a Surge Suppressor pull down menu 230. Screen shot 220 also includes a recommendation area 232 that specifies further information about the recommended product that in one embodiment includes a list price. Screen shot 220 further includes an Add to Bill of Material button 234, a View Bill of Material button 236, and a Controller Selection button 238, as well as a Features and Benefits display area 240.

Selection of Add to Bill of Material button 234 adds the selected item to the bill of material. View Bill of Material button 236 causes system 10 (shown in FIG. 1) to display a Bill of Material page, discussed below. Controller Selection button 238 takes the user to the assembled manual motor controller needs assessment page, shown in FIG. 4.

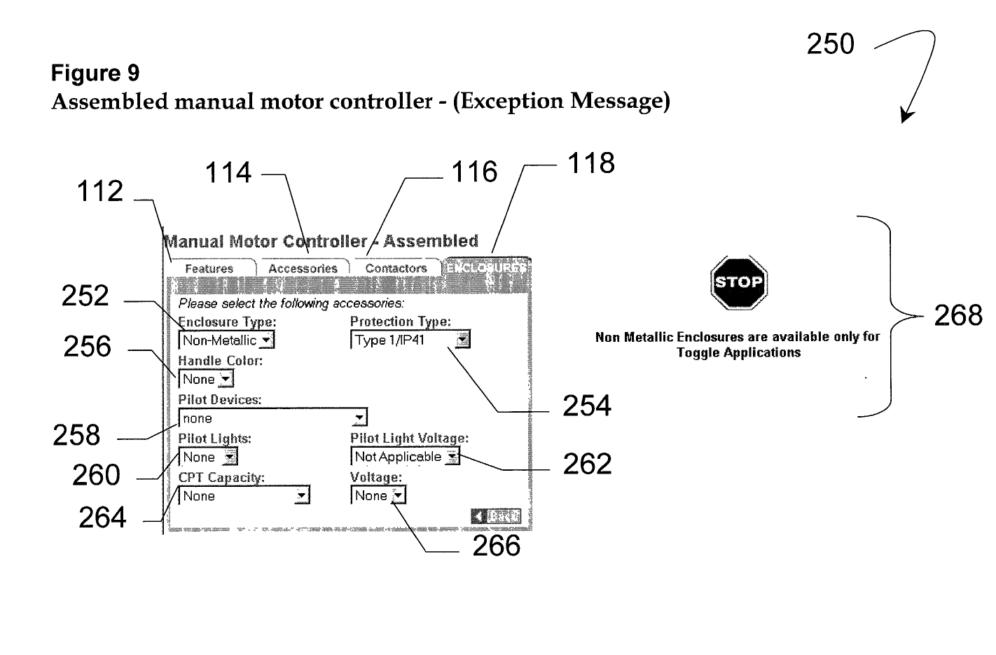

FIG. 9 is an exemplary embodiment of an assembled manual motor controller—assembled exception message page, as depicted in screen shot 250, which results from selection of Enclosures tab 114 shown in FIG. 5. Screen shot 250 includes an Enclosure Type pull down menu 252, a Protection Type pull down menu 254, a Handle Color pull down menu 256, a Pilot Devices pull down menu 258, a Pilot Lights pull down menu 260, a Pilot Light Voltage pull down menu 262, a CPT Capacity pull down menu 264, and a Voltage pull down menu 266. Screen shot 250 also includes a exception message area 268 that informs the user about an incompatibility in the options the user has selected for the assembled manual motor controller.

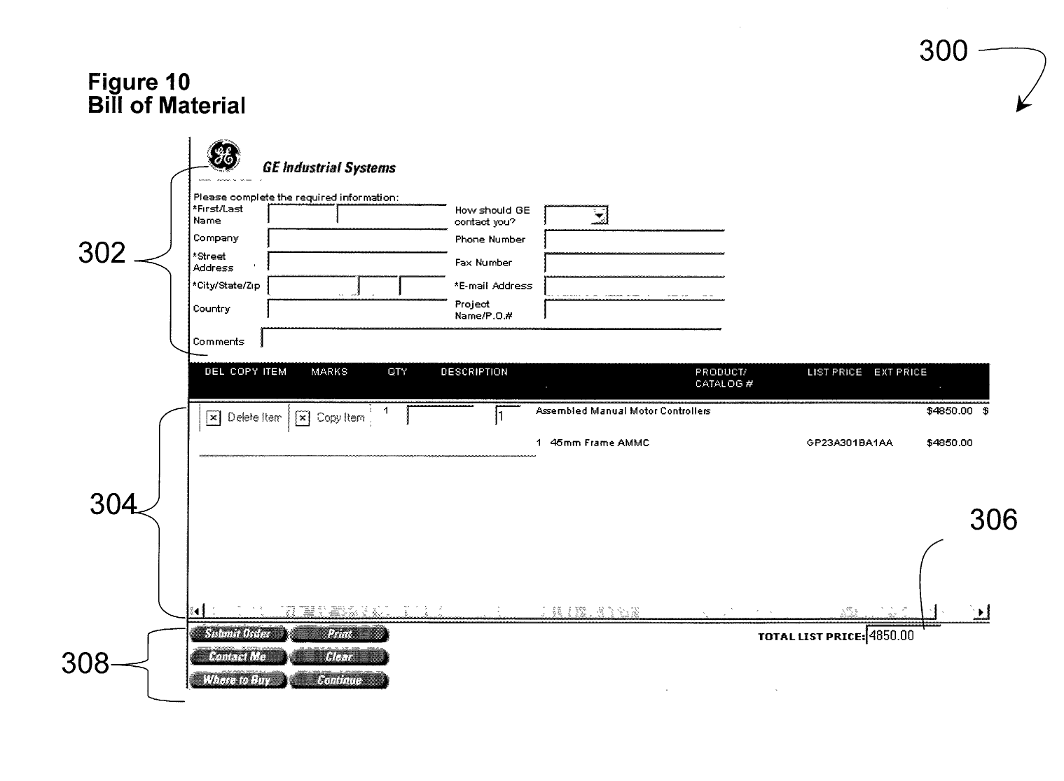

FIG. 10 is an exemplary embodiment of a Bill of Material page, as depicted in screen shot 300, that is downloaded and displayed by server system 12 when the user has selected “View Bill of Material” button 134 (shown in FIG. 5). Screen shot 300 includes a customer information area 302 where a user can specify contact information. Screen shot 300 also includes an order area 304 to display information about the order, including in one embodiment a specification of an item ordered, the quantity, description, catalog number, and price. Screen shot 300 further includes a List Price text box 306 that displays a total price of all items ordered. Screen shot 300 still further includes a set of buttons 308 that allow the user to submit the order, print the order, clear the bill of material, request that the user be contacted, find out where to buy the product, or continue.

In use, system 10 (shown in FIG. 1) provides the user with a complete assembled manual motor controller configured to meet the user's needs. The user selects the rating of the assembled manual motor controller, including power system rating, voltage rating, design requirements, number of poles, application, enclosure type, and any optional features. Based on these inputs system 10 displays the individual equipment price. System 10 does not allow the user to configure a selection that is invalid and guides the user by informing the user why the selected configuration is invalid. Once the customer has configured the product, the user can add it to the user's bill of materials and then view the bill of materials, which the user can optionally print, or submit as an order.

While the invention has been described in terms of various specific embodiments, those skilled in the art will recognize that the invention can be practiced with modification within the spirit and scope of the claim.

What is claimed is:

1. A method for facilitating selection of an assembled manual motor controller through use of a network-based system including a server and at least one device connected to the server via a network, said method comprising the steps of:
receiving product specification information from a user via the device;
comparing the received product specification information with pre-stored assembled manual motor controller information;
selecting at least one assembled manual motor controller that matches the received product specification information; and
displaying the information related to the assembled manual motor controller.

2. A method according to claim 1 wherein said step of comparing the received product specification information comprises the steps of:
determining whether the features selected are available for the selected assembled manual motor controller configuration; and
displaying a message if the selected features are not available for the selected assembled manual motor controller configuration.

3. A method according to claim 1 wherein said step of receiving product information data from a user further comprises the step of receiving an identification for the product.

4. A method according to claim 1 wherein said step of displaying information related to the assembled manual motor controller comprises the step of displaying the features selected for the assembled manual motor controller.

5. A method according to claim 1 wherein said step of displaying information related to the assembled manual motor controller comprises the step of displaying the accessories selected for the assembled manual motor controller.

6. A method according to claim 1 wherein said step of displaying information related to the assembled manual motor controller comprises the step of displaying a catalog number and a list price for the assembled manual motor controller.

7. A method according to claim 1 wherein said step of displaying information further comprises the step of generating a quotation for the assembled manual motor controller.

8. A method according to claim 1 wherein the product specification information is received from the user via a graphical user interface.

9. A method according to claim 1 further comprising the step of assessing a need of the user based on at least one of a product application, product parameters, desired product features, and product accessories.

10. A method according to claim 1 further comprising the step of validating configuration compatibility based on the received product specification information to determine whether a resulting assembled manual motor controller having the received product specifications is capable of meeting parameters of the product.

11. A method according to claim 13 further comprising the step of guiding the user, if the resulting product does not meet the parameters of the product, to a correct product configuration.

12. A method according to claim 10 further comprising the step of guiding the user to a compatible product.

13. A system for facilitating selection of an assembled manual motor controller, said system comprising:
a device; and
a server connected to said device and configured to receive product specification information data from a user via said device, said server further configured to:
compare the received product specification information with pre-stored assembled manual motor controller information;
select at least one assembled manual motor controller from the pre-stored assembled manual motor controller information based on assembled manual motor controller identification criteria entered by the user; and
display information related to the assembled manual motor controller based on the assembled manual motor controller identification criteria.

14. A system according to claim 13 wherein said server further configured to download to the user the information related to the assembled manual motor controller.

15. A system according to claim 13 wherein said server further configured to:
determine whether the features selected are available for the selected assembled manual motor controller configuration; and
display a message if the selected features are not available for the selected assembled manual motor controller configuration.

16. A system according to claim 13 wherein said server further configured to receive an identification for the product.

17. A system according to claim 13 wherein said server further configured to display the dimensions of the assembled manual motor controller.

18. A system according to claim 13 wherein said server further configured to display the accessories selected for the assembled manual motor controller.

19. A system according to claim 13 wherein said server further configured to:
determine whether the features selected are available for the selected assembled manual motor controller configuration; and
display a message if the selected features are not available for the selected assembled manual motor controller configuration.

20. A system according to claim 13 wherein said server further configured to receive an identification for the product.

21. A system according to claim 13 wherein said server further configured to display the features selected for the assembled manual motor controller.

22. A system according to claim 13 wherein said server further configured to display the accessories selected for the assembled manual motor controller.

23. A system according to claim 13 wherein said server further configured to display a catalog number and a list price for the assembled manual motor controller.

24. A system according to claim 13 wherein said server further configured to generate a quotation for the assembled manual motor controller.

25. A system according to claim 13 wherein said server further configured to receive the product specification information from the user via a graphical user interface.

26. A system according to claim 13 wherein said server further configured to assess a need of the user based on at least one of a product application, product parameters, desired product features, and product accessories.

27. A system according to claim 26 wherein said server further configured to validate configuration compatibility based on the received product specification information to determine whether a resulting assembled manual motor controller having the received product specifications is capable of meeting parameters of the product.

28. A system according to claim 27 wherein said server further configured to guide the user, if the resulting product does not meet the parameters of the product, to a correct product configuration.

29. A system according to claim 28 wherein said server further configured to guide the user to a compatible product.

30. A system according to claim 13 wherein said server further configured to accept a purchase order for the assembled manual motor controller after the purchase order has been authenticated against pre-determined criteria.

31. A system according to claim 13 wherein said device configured to be a server for a network of customer devices.

32. A system according to claim 13 wherein said server and said device are connected via a network.

33. A system according to claim 32 wherein said network is one of a wide area network, a local area network and the Internet.
